(19) United States
(12) Patent Application Publication
(10) Pub. No.: US 2022/0390154 A1
(43) Pub. Date: Dec. 8, 2022

(54) ADSORPTION REFRIGERATION MACHINE OR HEAT PUMP WITH A LIQUID-PHASE REFRIGERANT DISTRIBUTION FUNCTION, AND METHOD FOR OPERATING THE ADSORPTION REFRIGERATION MACHINE OR HEAT PUMP

(71) Applicant: SORPTION TECHNOLOGIES GMBH, Freiburg (DE)

(72) Inventor: Walter Mittelbach, Freiburg (DE)

(21) Appl. No.: 17/774,542

(22) PCT Filed: Nov. 6, 2020
(86) PCT No.: PCT/EP2020/081347

§ 371 Date: May 26, 2022

(30) Foreign Application Priority Data
Nov. 7, 2019 (DE) 10 2019 130 107.6

(51) Int. Cl. F25B 35/04; F25B 30/04; F25B 39/00; F25B 41/28

(52) U.S. Cl. CPC F25B 35/04; F25B 30/04; F25B 39/00; F25B 41/28; F25B 2500/18; F25B 2315/002; F25B 39/026

(57) ABSTRACT

The invention relates to an adsorption refrigerator or an adsorption heat pump as well as a method for the operation thereof. The adsorption refrigerator or adsorption heat pump comprises at least one module having an adsorber, a mixing evaporator and a mixing condenser. It is characterized in that the adsorber together with the mixing evaporator and the mixing condenser within the module is structurally combined and contained within a common, preferably thermally insulated adsorber container for accommodating the adsorber and having an adsorber section which can be thermally contacted externally, and having a mixing section thermally insulated externally for accommodating the mixing evaporator and the mixing condenser, wherein the mixing section is formed so that a refrigerant can flow through it, so that the refrigerant, after having flown through the mixing section, can be supplied to an external heat exchanger that is separated from the module, wherein the mixing section is arranged to enable the refrigerant to be evaporated and/or condensed.

The invention relates to an adsorption refrigerator or an adsorption heat pump according to the preamble of claim 1, and to a method for operating an adsorption refrigerator or an adsorption heat pump according to claim 13.

Adsorption refrigerators or adsorption heat pumps usually consist of an adsorber, an evaporator and a condenser. In this case, the evaporator and the condenser may also be combined into one evaporator/condenser in a device. In the adsorber, refrigerant is adsorbed while evaporating from the condenser and withdrawing heat from the environment there via an external heat contact. In a subsequent desorption step, the refrigerant is ejected from the adsorber by external heat supply. The desorbed refrigerant is condensed again within the condenser, and thereby emits the heat extracted beforehand during the evaporation process and the heat supplied during desorption via a further heat contact to the environment. Hereby, heat is pumped from the heat contact of the evaporator to the heat contact of the condenser.

Usually, two or more adsorbers are employed in order to enable continuous refrigerating or continuous heat pumping. These two adsorbers carry out the corresponding adsorption and desorption process in a push-pull mode and are mutually coupled to the condenser or the evaporator correspondingly so that evaporating and condensing of the refrigerant may also be performed virtually continuously and in the push-pull mode.

Since water is very often used as refrigerant in such installations, the following complex of problems will be the result for the construction of the thus configured adsorption refrigerators and adsorption heat pumps:

If separated apparatuses are intended to be provided for the evaporator and the condenser, the connecting pipes and valves between the components need to have a large flow cross-section due to the low density of water vapor. Specifically, at low evaporating temperatures, this will be an obstacle to cost-efficient construction.

If an apparatus is intended to be alternately used for evaporating and condensing the refrigerant, which apparatus thus acts as an evaporator/condenser, a large flow cross-section may indeed be realized in a structurally simple manner. However, it is problematic in case of such a configuration that not only the adsorber but also the evaporator/condenser oscillate between two temperature levels in this case. Because the evaporator/condenser necessarily needs to be brought into heat contact with a first temperature and thereafter into heat contact with a second temperature, which is inevitably different from the first temperature.

Due to the thermal mass and the limited options for heat recovery, this oscillating between two temperature levels leads to performance losses and deterioration of the thermal efficiency of the adsorption refrigerator or the adsorption heat pump.

It is therefore the task on which the invention is based to propose an adsorption refrigerator or an adsorption heat pump and a method for operating such a device, by means of which the mentioned disadvantages can be avoided. In particular, the losses are intended to be minimized by the thermal mass of the evaporator, the condenser or the evaporator/condenser.

The solution of the task is performed with an adsorption refrigerator or an adsorption heat pump having the features of claim 1, and a method for operating an adsorption refrigerator or an adsorption heat pump having the features of claim 13.

The adsorption refrigerator or the adsorption heat pump comprises at least one module having an adsorber, a mixing evaporator and a mixing condenser. According to the invention, the adsorption refrigerator or the adsorption heat pump is characterized in that the adsorber having the mixing evaporator and the mixing condenser is structurally combined and contained within a common, preferably thermally insulated adsorber container having an adsorber section that can be thermally contacted externally, for accommodating the adsorber, and an externally insulated mixing section for accommodating the mixing evaporator and the mixing condenser. In this case, the mixing section is formed so that a refrigerant can flow through it so that, after flowing through the mixing section, the refrigerant can be supplied to an external heat exchanger which is separated from the module, wherein the mixing section is arranged to enable the refrigerant to be evaporated and/or condensed.

A solution thus is proposed according to the invention, in which refrigerant distribution between the adsorbers is omitted in the vapor phase. The refrigerant in the vapor phase exclusively exists within the respective module in the adsorber container of which the corresponding adsorber is located. At the same time, the refrigerant itself, more specifically, the section of the refrigerant not making a phase change during evaporation and condensation, serves as a heat transport means for transferring heat to an external heat exchanger. This additionally enables a constructional separation between the components in which the evaporation or condensation proceeds, and the components which are necessary for the heat transfer with external low temperature ranges or medium temperature ranges. In this respect, it is decisive that the module according to the invention is thermally insulated and only thermal contacting of the adsorber with an external heat carrier medium is provided for switching between an adsorption and desorption operation of the adsorber. The actual transfer of useful heat is performed in an external heat exchanger which is separated from the module and is spatially-physically and thermally separated from the interior space of the adsorber container and in particular the mixing evaporator and mixing condenser disposed therein. The adsorber container preferably is realized to be gas-tight and to be able to be evacuated or adjusted to negative pressure so as to promote evaporation processes and the vapor exchange between the adsorber area and the mixing area.

In one embodiment, a separating means impermeable for liquid droplets, in particular a separating screen, is provided within the adsorber container which partitions the adsorber section and the mixing section. Hereby, the adsorber material is prevented from being impinged on directly and undesirably by the refrigerant flowing within the mixing section.

In a further embodiment, the adsorber section and the mixing section constitute a concentric arrangement at least in sections within the adsorber container. Hereby, the adsorber section can be utilized universally and intensively for adsorption and desorption processes, wherein the available space can be used in a technically optimal manner.

In a variant, the adsorber section in the concentric arrangement is in particular surrounded by the mixing section.

Appropriately, the mixing section, when being flown through by the refrigerant, is formed to provide a refrigerant flow as a divided liquid flow, wherein the adsorption container contains means for generating droplets. The area of the refrigerant flow is thereby greatly enlarged.

In particular in one embodiment, the means for generating droplets can be formed as a bulk of fillers.

But an embodiment is also possible in which the means for generating droplets is formed as an atomization device.

Moreover, in a further embodiment, the means for generating droplets may be an arrangement of installations partitioning the liquid flow and being capable of wetting it, for forming a permanent wetting liquid film. In such a case, the refrigerant flow runs across the surface of the installations which is subdivided many times, whereby it is divided and split up so that its surface as well is enlarged in a sustainable manner.

In one embodiment, the mixing evaporator and the mixing condenser are structurally combined in a unit formed as a mixing evaporator/mixing condenser.

In a further embodiment, the mixing section is formed as a combined structure for a mixing evaporator/condenser.

In a possible other embodiment, the mixing section may have a first subsection for a mixing evaporator and a second subsection for a mixing condenser. The evaporation and condensation are performed in this embodiment at different locations within the adsorption container.

In a possible embodiment of the adsorption refrigerator or adsorption heat pump, this embodiment is characterized by an arrangement of at least two modules through which arrangement a refrigerant can flow, and an arrangement of at least one heat exchanger for thermally coupling to a low temperature range and at least one heat exchanger for thermally coupling to a medium temperature range, a pump arrangement for generating a refrigerant flow, and a valve circuit for alternatingly coupling the modules to the at least one heat exchanger of the low temperature range and the at least one heat exchanger of the medium temperature range. Hereby, the basic principle of an arrangement of two or even more modules working in the push-pull mode is realized, which continuously generates coldness or pumps heat.

Within the scope of the present invention, a method for operating an adsorption refrigerator or an adsorption heat pump comprising at least one adsorber, a mixing evaporator and a mixing condenser is further indicated. The method according to the invention for operating an adsorption refrigerator or an adsorption heat pump comprising at least one adsorber, a mixing evaporator and a mixing condenser, wherein the adsorber is structurally combined with the mixing evaporator and the mixing condenser in a common module, is performed such that a refrigerant desorbed from the adsorber is condensed into a refrigerant flow generated in the mixing condenser, and/or a refrigerant evaporated from the refrigerant flow in the mixing evaporator is adsorbed at the adsorber.

In this case, the portion of the refrigerant flow not participating in the evaporation and/or condensation is conducted, as a heat transferring fluid, to a downstream external heat exchanger in thermal coupling with a low temperature range and/or medium temperature range.

In one configuration of the method, at least one first module, at least one heat exchanger in thermal coupling with the low temperature range, and at least one heat exchanger in thermal coupling with a medium temperature range, as well as at least one second module are provided, wherein an alternating thermal coupling of the modules to the low temperature range and medium temperature range is performed via two interlaced refrigerant circuits containing the refrigerant flow, and wherein the refrigerant is used as a heat transferring fluid.

Due to the alternating thermal, in particular also fluidic coupling of the modules to the heat exchanger being in thermal coupling with the medium temperature range, and the heat exchanger being in thermal coupling with the low temperature range, the module, which is in contact with the heat exchanger for the medium temperature range, can be operated in the desorption mode, in which refrigerant adsorbed at the adsorber of the module is expelled and condenses at the refrigerant flow. The heat in this case transferred to the refrigerant is then discharged via the coupled heat exchanger, which is in thermal contact with the medium temperature range or low temperature circuit. The module, which is in contact with the heat exchanger for the low temperature range, is operated in the adsorption mode, in which water vapor evaporating from the refrigerant flow is adsorbed at the adsorber of the module. In this case, heat is withdrawn from the refrigerant flow so that the refrigerant exiting the module can be used in the heat exchanger for the low temperature range for cooling the low temperature range or low temperature circuit. Thereby, continuous operation of the adsorption refrigerator or adsorption heat pump is enabled.

It should be pointed out here that the features and achievable advantages described with respect to the adsorption refrigerator or adsorption heat pump according to the invention also apply to the method according to the invention and are correspondingly transferable and applicable. Likewise, the described features and advantages of the method are applicable and transferable to the adsorption refrigerator or adsorption heat pump according to the invention.

The adsorption refrigerator or adsorption heat pump according to the invention and the associated method will be explained in more detail hereinafter on the basis of illustrative exemplary embodiments. The attached Figures serve for clarification.

Shown are in:

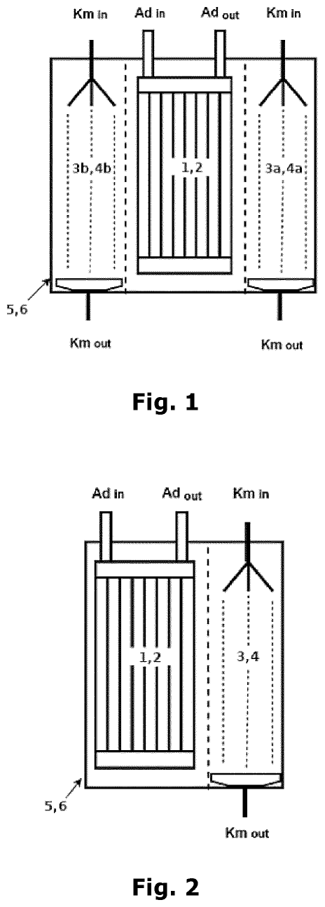

FIG. 1 an exemplary module according to a first exemplary embodiment,

FIG. 2 an exemplary module according to a second exemplary embodiment,

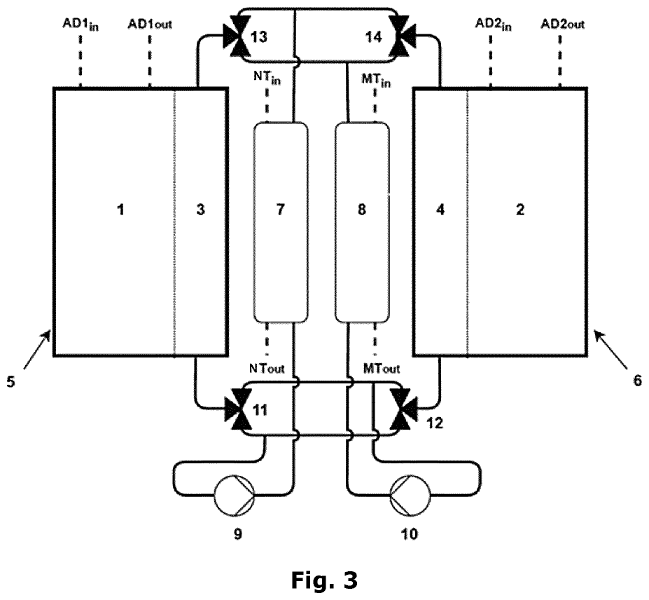

FIG. 3 an adsorption refrigerator or adsorption heat pump according to an exemplary embodiment of the present invention.

FIG. 1 shows an exemplary module 5, 6 for use in an adsorption refrigerator or adsorption heat pump according to the invention in accordance with a first exemplary embodiment. The module 5, 6 is delimited by an adsorber container, the exterior walls of which are schematically represented in FIG. 1. The adsorber container has an adsorber area arranged to be centered, which is delimited by the dashed lines in FIG. 1. A mixing area is joined to both sides of the adsorber area. The adsorber area contains an adsorber 1, 2, which has terminals Adᵢₙ and Adₒᵤₜ via which a thermal contact of the adsorber 1, 2 with an external heat source may be established. The adsorber 1, 2 is surrounded on both sides by a mixing evaporator 3a, 4a and a mixing condenser 3b, 4b arranged within the mixing area. The mixing evaporator 3a, 4a and the mixing condenser 3b, 4b may enclose the adsorber 1, 2 on all sides and concentrically. Here, the shape of cylinders pushed into one another is in particular possible. In this respect, the schematic representation of the arrangement of the components within the module 5, 6 is only of a principal nature and does not represent any restriction concerning the configuration of the components of the module 5, 6.

The interior space of the adsorber container of the module 5, 6 serves as a phase transition space for a refrigerant conducted through the mixing areas and the mixing evaporators 3a, 4a and mixing condensers 3b, 4b arranged there. As shown in FIG. 1, refrigerant is introduced into the mixing evaporator 3a, 4a and the mixing condenser 3b, 4b via terminals designated KMᵢₙ into an atomization device and is split up into a refrigerant flow in droplet form. The refrigerant flow is collected in the lower area of the mixing evaporator 3a, 4a and the mixing condenser 3b, 4b, for example by a schematically represented collection device, and is discharged via terminals designated KMₒᵤₜ for being supplied to downstream components of the adsorption refrigerator or adsorption heat pump, in particular for being supplied to heat exchangers. The mixing area, in which the mixing evaporator 3a, 4a and the mixing condenser 3b, 4b are arranged, and in which a refrigerant flow is formed by supplying refrigerant, is the place into which the condensation or from which the evaporation of the refrigerant is performed. The refrigerant flow heats up during condensation and cools down during evaporation.

Thus, the refrigerant flow, more precisely, the part of the refrigerant not participating in the phase transition in the module 5, 6, serves as a heat transport means within the module 5, 6. Principally, heat exchange with the external environment is not intended within the mixing areas and the mixing evaporator 3a, 4a and mixing condenser 3b, 4b provided there. Only the adsorber 1, 2 is thermally contacted externally via the terminals ADᵢₙ and ADₒᵤₜ. In this respect, the construction of the module 5, 6 differs fundamentally from the construction of conventional refrigerators in which evaporators and condensers, which are in direct thermal contact with an adsorber, function as heat exchangers for transferring heat to an external heat carrier medium. In the module 5, 6 according to the present invention, the heat transfer to an external heat carrier medium is not performed by conducting heat to a heat exchanger contained within the phase transition space, but is performed directly by cooling or heating the proportion of the refrigerant exiting the adsorber container or the module 5, 6. The proportion of the refrigerant not participating in the phase transition in the phase transition space serves for transferring heat in an external heat exchanger.

Between the mixing areas and the adsorber area, a separating means, in particular a separating lattice or a separating screen is arranged. The separating means prevents liquid droplets from directly passing from the mixing area into the adsorber area. Thereby, it is ensured that only the gaseous phase of the refrigerant reaches the adsorber 1, 2 or penetrates from the adsorber 1, 2 to the refrigerant flow.

FIG. 2 shows an alternative exemplary embodiment of a module 5, 6 according to the invention. The module 5, 6 again is delimited by an adsorber container forming the phase transition space. Within the adsorber container, an adsorber area is formed accommodating an adsorber 1, 2. Furthermore, a mixing area is formed being in thermal contact with the adsorber area. In contrast to the configuration shown in FIG. 1, the mixing area, instead of a separated mixing evaporator 3a, 4a and mixing condenser 3b, 4b, contains a combined mixing evaporator/condenser 3, 4 functioning as a mixing evaporator or as a mixing condenser depending on the operation of the module 5, 6. This allows the required constructional space for the module 5, 6 and the number of the required terminals to be reduced. Otherwise, the configuration and operating mode correspond to the module shown in FIG. 1.

If in the modules 5, 6 shown in FIG. 1 and FIG. 2, the adsorber 1, 2 is connected to a medium temperature circuit so as to adsorb refrigerant, heat is withdrawn from the refrigerant flow by the mixing evaporator 3a, 4a (FIG. 1) or the refrigerant flow in the mixing evaporator/condenser 3, 4 (FIG. 2). The refrigerant flow consequently is cooled. If the saturated adsorber 1, 2 is connected to a high temperature circuit for desorption, refrigerant from the adsorber 1, 2 desorbs and condenses at the refrigerant flow by the mixing evaporator 3a, 4a (FIG. 1) or the mixing evaporator/condenser 3, 4 (FIG. 2). In this case, the refrigerant flow absorbs heat.

In order to make the heat withdrawn from or supplied to the refrigerant flow useful, the refrigerant flow from the module 5, 6 is supplied to a heat transferring device spatially-physically and thermally separated from the module 5, 6 for establishing thermal contact with an external heat carrier medium. As already explained above, this is a core idea of the present invention.

FIG. 3 shows an adsorption refrigerator or adsorption heat pump according to an exemplary embodiment of the present invention with a first module 5 and a second module 6 of the kind described above, and an associated refrigerant circuit.

The exemplary adsorption refrigerator according to FIG. 3 has two modules 5, 6 in each of which an adsorber 1, 2 is positioned. The modules 5,6 are schematically represented in FIG. 3, and their structure is reduced to the contained adsorbers 1, 2 and mixing evaporators/condensers 3, 4. It is likewise possible to form one or both of the modules 5, 6 according to the configuration shown in FIG. 1.

Within the adsorber areas, the modules 5, 6 furthermore each contain a heat transferring device in contact with the adsorbent, which is introduced, for example, as bulk or is applied to the heat transfer surface by a coating method. The mixing area for the mixing evaporator/condenser 3, 4 within the modules 5, 6 may either contain only the spray unit or additionally fillers or structures for improving the phase transition, and may be separated from the adsorber space by a web serving as a droplet separator (broken line in the drawing), as has already been explained above with respect to FIGS. 1 and 2.

The heat transfer to the heat carrier circuits for the low temperature range NT and the condenser part of the medium temperature range MT^{cd} is performed by two heat transferring devices 7, 8, which in each usual constructional form can be realized for transferring heat of a liquid, i.e. the refrigerant, to a heat carrier fluid (water, heat transfer oil, air, or other gases, vapor, secondary refrigerants in case of cascade connection of refrigerators) of the heat carrier circuits.

The refrigerant is controlled by two pumps 9, 10 and a valve assembly 11, 12, 13, 14, represented in FIG. 3 by four three-way valves 11, 12, 13, 14, in such a manner that alternatingly, the heat exchanger 7 is connected to the mixing evaporator/condenser 3, and the heat exchanger 8 is connected to the mixing evaporator/condenser 4, and the heat exchanger 7 is connected to the mixing evaporator/condenser 4, and the heat exchanger 8 is connected to the mixing evaporator/condenser 3. Instead of the three-way valves 11, 12, 13, 14, respective 2 of two-way valves or special valves are also possible.

The module, the mixing evaporator/condenser of which is connected to the first heat exchanger 7, is operated in the adsorption mode. In this case, the associated adsorber of the module is connected to the medium temperature circuit MT^{ad} so as to cause the refrigerant evaporated from the refrigerant flow to be adsorbed at the adsorber. In this case, the refrigerant flow is cooled down and can be employed for cooling the low temperature circuit within the first heat exchanger 7.

The module, the mixing evaporator/condenser of which is connected to the second heat exchanger 8, is operated in the desorption mode. In this case, the associated adsorber of the module is connected to a high temperature circuit so as to cause the refrigerant to be desorbed at the adsorber and expel refrigerant from the adsorber, which condenses at the refrigerant flow within the mixing evaporator/condenser. In this case, the refrigerant flow is heated up. The heated refrigerant is supplied to the second heat exchanger 8 in order to release the heat there.

If a low-pressure refrigerant, such as water, is used as the refrigerant, the pumps 9, 10, valves 11, 12, 13, 14, heat exchangers 7, 8, as well as the refrigerant circuits need to be realized in a vacuum-tight manner. The pumps 9, 10 are then advantageously coupled magnetically with the drive and must be installed in a manner that cavitation is avoided.

The two adsorber circuits AD1 and AD2 are connected in a known manner by three-way valves to the external high temperature HT circuits and the adsorber part of the medium temperature circuit MT^{ad}.

In the exemplary embodiment described in FIG. 3, the shown device is operated as an adsorption refrigerator. It is likewise possible to use the shown device as an adsorption heat pump by using the medium temperature circuit connected to the second heat exchanger 8 as the utility circuit.

The construction according to the invention of the adsorption refrigerator or adsorption heat pump allows the evaporation/condensation process at the adsorbers and the heat transfer between the refrigerant and a heating or cooling fluid to be decoupled. As explained above with respect to FIGS. 1 and 2, the refrigerant is directly introduced into the adsorber chamber of the modules according to the principle of mixing evaporator or mixing condenser, where it either evaporates or expelled refrigerant condenses at the surface. This method is also referred to as direct phase transition (evaporation/condensation). Here, the heat transfer to an external heat carrier medium is not performed by heat conduction to a heat transferring device contained within the phase transition space, but is performed directly by cooling or heating the proportion of the liquid exiting the phase transition space. The proportion of the liquid not participating in the phase transition serves for transferring heat into an external heat transferring device.

For the refrigerant distribution in the phase transition space, all known devices for direct phase transition may be employed such as the described atomization devices, but also spraying devices, fillers for surface distribution (e.g. Raschig or Pall rings), areal distribution variants, through to porous structures as employed in cooling towers. In case of sensitive adsorbents, e.g. some silicate gels and zeolites having water as refrigerant, it is recommendable to add protection in order to avoid liquid from directly entering into the adsorber in the form of droplets. In case of low-pressure refrigerant, such as water, attention has to be paid especially to the vacuum suitability of the installations. This applies to the employed pumps, as well, which ideally are hermetically sealed by magnetic coupling. In the pump selection and conduit construction (especially on the exhaust side), attention has to be paid to avoid cavitation.

If this principle is applied in an adsorption refrigerator and the refrigerant alternatingly evaporates or condenses within the adsorber container, the heat transfer to the two external heat carrier circuits of the low temperature circuit and the medium temperature circuit may be performed in separated heat transferring devices without these oscillating between the evaporating temperature and the condensing temperature. The temperature oscillations extend in this case only to the refrigerant distribution, possibly to installations for improving the phase transition (e.g. fillers, the thermal mass of which, however, can be limited by low material thicknesses or the use of plastics), and the pipe sections between the module inlet/outlet and valves, which, however can be kept very short.

The advantages of the adsorption refrigerator or adsorption heat pump described here, and of the method described here for the operation thereof, result in summary as follows:
Improvement of performance and thermal efficiency by reducing the thermal mass within the oscillating proportion of evaporation and condensation.
The phase transition and heat transition can be optimized separately by a respective efficient apparatus, e.g. by Pall rings and plate heat exchangers. This considerably improves the total efficiency since an oscillating evaporator/condensation apparatus cannot be optimized for both tasks. In addition, there is a contradiction between the two target directions: large surface for the phase transition and short paths for the heat transition.
Possibility of direct heat transfer between process water and air or gases without any interconnected heat carrier circuit for the low temperature circuit and/or the condenser part of the medium temperature circuit. When the adsorption refrigerator is employed as an outdoor device, this enables a directly air-cooled unit to be built, when a return cooler is equipped with two separated pipe circuits for condensing, and for cooling the adsorber.
Possibility of direct heat transfer between process water and air or gases without any interconnected heat carrier circuit for the low temperature circuit. When the adsorption refrigerator is employed as an indoor device, this enables a directly air-cooled unit to be built, in particular when there is no long line path between the adsorption refrigerator and the air cooler. This can be applied e.g. in rack integrated adsorption refrigerators which utilize exhaust heat from water-cooled processors for driving. Since the liquid is under vacuum, a leakage-safe construction may be selected here as an additional advantage, since in the event of leakage, air will flow in and press the liquid e.g. into a reservoir.
Very compact construction possibility for the modules, when the evaporating or condensing spaces are arranged at the exterior surfaces or in an annular shape around the adsorber. The flow thereby reaches the adsorber evenly from all sides, the flow cross-sections are maximum, thus the vapor velocities are very low, and the heat losses of the adsorber with respect to the environment are minimized.
Very simple possibility for removing inert gases from the system, since the inert gases are better absorbed in the liquid due to the large surface. The removal of the inert gases is performed directly at the outlet of the valves, since the pressure is highest there. Degassing may then be performed according to common methods by membranes or fillers. When the pump design does not allow an overpressure of over one bar, then there is also the possibility of generating a low vacuum, e.g. 500 mbar, by means of a simple vacuum pump in a secondary container, which is emptied automatically on a regular basis.

The subject matter of the invention has been explained on the basis of exemplary examples of embodiments. Further configurations are possible within the scope of skilled operation. Further embodiments moreover will result from the dependent claims.

### LIST OF REFERENCE NUMERALS

1 first adsorber
2 second adsorber
3 first mixing evaporator/condenser
3a first mixing evaporator
3b first mixing condenser
4 second mixing evaporator/condenser
4a second mixing evaporator
4b second mixing condenser
5 first module
6 second module
7 NT circuit of heat exchanger or heat transferring means
8 MT circuit of heat exchanger or heat transferring means
9 evaporator refrigerant pump
10 condenser refrigerant pump
11 to 14 valve circuit

1. An adsorption refrigerator or adsorption heat pump, comprising at least one module (5, 6) having an adsorber (1, 2), a mixing evaporator (3a, 4a) and a mixing condenser (3b, 4b),
characterized in that
the adsorber (1, 2) together with the mixing evaporator (3a, 4a) and the mixing condenser (3b, 4b) within the module (5, 6) is structurally combined and contained within a common, preferably thermally insulated adsorber container for accommodating the adsorber (1, 2) and having an adsorber section which can be thermally contacted externally, and having a mixing section thermally insulated externally for accommodating the mixing evaporator (3a, 3b) and the mixing condenser (4a, 4b), wherein the mixing section is formed so that a refrigerant can flow through it, so that the refrigerant, after having flown through the mixing section, can be supplied to an external heat exchanger (7, 8) that is separated from the module (5, 6), wherein the mixing section is arranged to enable the refrigerant to be evaporated and/or condensed.

2. The adsorption refrigerator or adsorption heat pump according to claim 1,
characterized in that
a separating means impermeable for liquid droplets, in particular a separating screen, is provided within the adsorber container, which separating means partitions the adsorber section and the mixing section.

3. The adsorption refrigerator or adsorption heat pump according to claim 1,
characterized in that
the adsorber section and the mixing section constitute a concentric arrangement at least in sections within the adsorber container.

4. The adsorption refrigerator or adsorption heat pump according to claim 3,
characterized in that
the adsorber section in the concentric arrangement is surrounded by the mixing section.

5. The adsorption refrigerator or adsorption heat pump according to claim 1,
characterized in that
the mixing section, when being flown through by the refrigerant, is formed to provide a refrigerant flow as a divided liquid flow, wherein the adsorption container contains means for generating droplets.

6. The adsorption refrigerator or adsorption heat pump according to claim 5,
characterized in that
the means for generating droplets is formed as a bulk of fillers.

7. The adsorption refrigerator or adsorption heat pump according to claim 6,
characterized in that
the means for generating droplets is formed as an atomization device.

8. The adsorption refrigerator or adsorption heat pump according to claim 5,
characterized in that
the means for generating droplets is an arrangement of installations partitioning the liquid flow and being capable of wetting it, for forming a permanent wetting liquid film.

9. The adsorption refrigerator or adsorption heat pump according to claim 1,
characterized in that
the mixing evaporator (3a, 4a) and the mixing condenser (3b, 4b) are structurally combined in a unit formed as a mixing evaporator/mixing condenser (3, 4).

10. The adsorption refrigerator or adsorption heat pump according to claim 1,
characterized in that
the mixing section is formed as a combined structure for a mixing evaporator/condenser (3, 4).

11. The adsorption refrigerator or adsorption heat pump according to claim 1,
characterized in that
the mixing section has a first subsection for a mixing evaporator (3a, 4a) and a second subsection for a mixing condenser (3b, 4b).

12. The adsorption refrigerator or adsorption heat pump according to claim 1,
characterized by
an arrangement of at least two modules (5, 6) through which arrangement a refrigerant can flow, and an arrangement of at least one heat exchanger (7) for thermally coupling to a low temperature range (NT) and at least one heat exchanger (8) for thermally coupling to a medium temperature range (MT), a pump arrangement (9, 10) for generating a refrigerant flow, and a valve circuit (11, 12, 13, 14) for alternatingly coupling the modules (5, 6) to the at least one heat exchanger (7) of the low temperature range (NT) and the at least one heat exchanger (8) of the medium temperature range (MT).

13. A method for operating an adsorption refrigerator or an adsorption heat pump comprising at least one adsorber (1, 2), a mixing evaporator (3a, 4a) and a mixing condenser (3b, 4b), wherein
the adsorber (1, 2) is structurally combined with the mixing evaporator (3a, 4a) and the mixing condenser (3b, 4b) in a common module (5, 6),
wherein a refrigerant desorbed from the adsorber (1, 2) is condensed into a refrigerant flow generated in the mixing condenser (3b, 4b), and/or a refrigerant evaporated from the refrigerant flow in the mixing evaporator (3a, 4a) is adsorbed at the adsorber (1, 2),
wherein the portion of the refrigerant flow not participating in the evaporation and/or condensation is conducted, as a heat transferring fluid, to a downstream external heat exchanger (7, 8) in thermal coupling with a low temperature range (NT) and/or medium temperature range (MT).

14. The method according to claim 13,
characterized in that
at least one first module (5), at least one heat exchanger (7) in thermal coupling with the low temperature range (NT), and at least one heat exchanger (8) in thermal coupling with a medium temperature range or medium temperature circuit (MT), as well as at least one second module (6) are provided, wherein an alternating thermal coupling of the modules (5, 6) to the low temperature range or the low temperature circuit (NT) and the medium temperature range (MT) is performed via two interlaced refrigerant circuits containing the refrigerant flow, and wherein the refrigerant is used as a heat transferring fluid.
